(19) United States
(12) Patent Application Publication
(10) Pub. No.: US 2025/0347467 A1
(43) Pub. Date: Nov. 13, 2025

(54) CAN MAKING SYSTEM WITH HYDROGEN FIRED INFRARED OVEN AND WATER RECYCLING SYSTEM

(71) Applicant: Stolle Machinery Company, LLC, Centennial, CO (US)

(72) Inventors: Ian Kenneth Scholey, Barnsley (GB); John Nigel Grainger, West Yorkshire (GB); Stephen D. Christensen, Highlands Ranch, CO (US); Andrew Christopher Hyde, Littleton, CO (US)

(73) Assignee: Stolle Machinery Company, LLC, Centennial, CO (US)

(21) Appl. No.: 19/203,257

(22) Filed: May 9, 2025

Related U.S. Application Data
(60) Provisional application No. 63/645,254, filed on May 10, 2024.

(51) Int. Cl. F27B 9/36; B01D 53/00; B01D 53/26; F26B 3/30; F26B 25/00; F27D 17/28

(52) U.S. Cl. CPC F27B 9/36; B01D 53/002; B01D 53/265; F26B 3/305; F26B 25/006; F27D 17/28; B01D 2257/708; B01D 2257/80; F27M 2003/085

(57) ABSTRACT

A can making system includes a hydrogen fired oven structured to burn hydrogen to dry and/or cure coatings on can bodies conveyed through the hydrogen fired oven, and a water recycling system including a first condenser structured to receive water vapor from the hydrogen fired oven resultant from burning the hydrogen and to condense the water vapor into condensed water, and wherein the water recycling system is structured to provide the condensed water to another component of the can making system.

### CROSS REFERENCE TO RELATED APPLICATIONS

This application is a non-provisional application of and claims priority to U.S. Provisional Patent Application Ser. No. 63/645,254, filed May 10, 2024, entitled, “Can Making System With Hydrogen Fired Infrared Oven And Water Recycling System.”

### FIELD OF THE INVENTION

The disclosed concept relates generally to a can making system and, more particularly, to can curing and water recycling in a can making system.

### BACKGROUND OF THE INVENTION

Pin ovens are well known in the art and are widely used in the industry for drying the coating on the exterior of partially completed, open-ended beverage cans. A can decorator applies the coating to the exterior of the cans. The coating includes, but is not limited to, ink, enamel used to apply the label, an overcoat of lacquer or varnish, or both a printed label and overcoat. The oven includes a number of heaters, typically natural gas heaters, that generate a heated fluid (air). That is, natural gas is burned thereby heating the air. The heated air is generally maintained in a heated, enclosed space through which a conveyor chain follows a generally vertical serpentine path. As such, pin ovens occupy a large volume and have a complex motion assembly. That is, in order for the conveyor chain to have a path of sufficient length to allow the cans to cure, the enclosed space typically has a volume of about 75 m.³ This is a problem as the ovens occupy a large space within a processing facility. Further, burning natural gas generates pollution.

Some can curing ovens use infrared emitters to cure the coatings on cans. Infrared ovens that are fueled with natural gas still generate pollution. Some infrared ovens use electric power, which, while eliminating pollution resultant from burning natural gas, results in an increased use of electric power.

There remains room for improvement in the sustainability of can curing ovens and in the overall process of can making.

### SUMMARY OF THE INVENTION

In accordance with an aspect of the disclosed concept, a can making system includes a hydrogen fired oven structured to burn hydrogen to dry and/or cure coatings on can bodies conveyed through the hydrogen fired oven; and a water recycling system including a first condenser structured to receive water vapor from the hydrogen fired oven resultant from burning the hydrogen and to condense the water vapor into condensed water, and wherein the water recycling system is structured to provide the condensed water to another component of the can making system.

In accordance with another aspect of the disclosed concept, a can making system includes a gas fired oven structured to burn gas to dry and/or cure coating on can bodies conveyed through the gas fired oven; and a water recycling system including a condenser structured to receive vapors resultant from drying and/or curing coatings of the can bodies and to condense the vapors into liquid water and solid volatile organic compounds (VOCs), and wherein the water recycling system includes a separator structured to separate the liquid water from the VOCs, and wherein the water recycling system is structured to provide the liquid water to another component of the can making system.

In accordance with another aspect of the disclosed concept, a method of recycling water in a can making system includes drying and/or curing coatings on can bodies conveyed through a hydrogen fired oven by burning hydrogen in the hydrogen fired oven; receiving water vapor from the hydrogen fired oven resultant from burning the hydrogen; condensing the water vapor into condensed water; and providing the condensed water to another component of the can making system.

### BRIEF DESCRIPTION OF THE DRAWINGS

A full understanding of the invention can be gained from the following description of the preferred embodiments when read in conjunction with the accompanying drawings in which:

FIG. 1 is a schematic diagram of a portion of a can making system in accordance with an example embodiment of the disclosed concept.

### DETAILED DESCRIPTION OF THE INVENTION

It will be appreciated that the specific elements illustrated in the figures herein and described in the following specification are simply exemplary embodiments of the disclosed concept, which are provided as non-limiting examples solely for the purpose of illustration. Therefore, specific dimensions, orientations, assembly, number of components used, embodiment configurations and other physical characteristics related to the embodiments disclosed herein are not to be considered limiting on the scope of the disclosed concept.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies. As such, as used herein, “structured to [verb]” recites structure and not function. Further, as used herein, “structured to [verb]” means that the identified element or assembly is intended to, and is designed to, perform the identified verb. Thus, an element that is merely capable of performing the identified verb but which is not intended to, and is not designed to, perform the identified verb is not “structured to [verb].”

As used herein, “associated” means that the elements are part of the same assembly and/or operate together, or, act upon/with each other in some manner. For example, an automobile has four tires and four hub caps. While all the elements are coupled as part of the automobile, it is understood that each hubcap is “associated” with a specific tire.

As used herein, “correspond” indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are to fit “snugly” together. In that situation, the difference between the size of the components is even smaller whereby the amount of friction increases. If the element defining the opening and/or the component inserted into the opening are made from a deformable or compressible material, the opening may even be slightly smaller than the component being inserted into the opening. With regard to surfaces, shapes, and lines, two, or more, “corresponding” surfaces, shapes, or lines have generally the same size, shape, and contours.

As used herein, the term “number” shall mean one or an integer greater than one (i.e., a plurality). That is, for example, the phrase “a number of elements” means one element or a plurality of elements. It is specifically noted that the term “a ‘number’ of [X]” includes a single [X].

As used herein, a “radial side/surface” for a circular or cylindrical body is a side/surface that extends about, or encircles, the center thereof or a height line passing through the center thereof. As used herein, an “axial side/surface” for a circular or cylindrical body is a side that extends in a plane extending generally perpendicular to a height line passing through the center of the cylinder. That is, generally, for a cylindrical soup can, the “radial side/surface” is the generally circular sidewall and the “axial side(s)/surface(s)” are the top and bottom of the soup can. Further, as used herein, “radially extending” means extending in a radial direction or along a radial line. That is, for example, a “radially extending” line extends from the center of the circle or cylinder toward the radial side/surface. Further, as used herein, “axially extending” means extending in the axial direction or along an axial line. That is, for example, an “axially extending” line extends from the bottom of a cylinder toward the top of the cylinder and substantially parallel to a central longitudinal axis of the cylinder.

As employed herein, the terms “can” and “container” are used substantially interchangeably to refer to any known or suitable container, which is structured to contain a substance (eg., without limitation, liquid; food; any other suitable substance), and expressly includes, but is not limited to, beverage cans, such as beer and beverage cans, as well as food cans.

As used herein, a “can body” includes a base and a depending, or upwardly depending, sidewall. The “can body” is unitary. In this configuration, the “can body” defines a generally enclosed space. Thus, the “can body,” i.e, the base and sidewall, also include(s) an outer surface and an inner surface. That is, for example, a “can body” includes a sidewall inner surface and a sidewall outer surface.

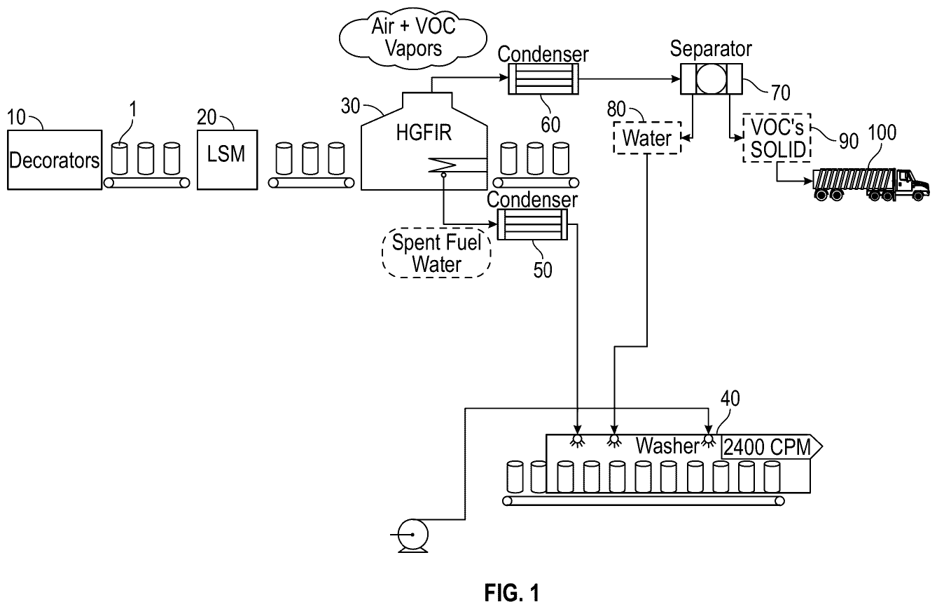

FIG. 1 is a schematic diagram of a portion of a can making system in accordance with an example embodiment of the disclosed concept. FIG. 1 shows the portion of the can making system beginning with a decorator 10. Prior portions of the can making system, which are not shown in FIG. 1, may include various processing machines, such as cuppers and bodymakers, to form a blank of metallic material into a can body 1. The can washer 40, shown in FIG. 1, may be located after the bodymakers, but before the decorator in the can making system. The decorator 10 and lacquer spray machine 20 are structured to receive the can bodies 1 and apply a coating to the exterior of the can bodies 1. The coating may include a printed ink label, applied by the decorator 10, and/or an overcoat of lacquer or varnish, applied by the lacquer spray machine 20. It will be appreciated that the can making system may include one or more decorators 10 or lacquer spray machines 20. It will also be appreciated that the decorator 10 or lacquer spray machine 20 may be omitted. In some example embodiments, the decorator 10 and/or lacquer spray machine 20 are capable of coating can bodies at a rate of about 2400 per minute.

The can making system further includes a hydrogen fired infrared oven 30. The hydrogen fired infrared oven 30 is structured to dry and/or cure can bodies 1 that have been coated by the decorator 10 and/or lacquer spray machine 20. The hydrogen fired infrared oven 30 may include a number of radiant heating plates. The hydrogen fired infrared oven 30 is fueled by hydrogen. The hydrogen is combusted in, for example, a combustion chamber, to generate heat. The heat is then transferred the radiant heating plates where it is emitted as infrared radiation.

The hydrogen fired infrared oven 30 may include a conveyor system structured to move the can bodies 1 through the hydrogen fired infrared oven 30. The radiant heating plates may be disposed laterally on sides of the conveyor system such that can bodies 1 moved by the conveyor system are exposed to the infrared radiation emitted by the radiant heating plates as the can bodies 1 pass by the radiant heating plates. The infrared radiation heats the can bodies 1 to a suitable temperature to dry and/or cure the coatings on the can bodies 1 as they pass through the hydrogen fired infrared oven 30. In some example embodiments, the hydrogen fired infrared oven 30 is capable of drying and/or curing a can body in about 2.5 seconds. In some example embodiments, the hydrogen fired infrared oven 30 includes about a 9 meter length in which the can bodies 1 are exposed to the radiant heating plates. That is, in some example embodiments, the hydrogen fired infrared oven 30 uses less space than a conventional pin oven, thus reducing the footprint of the can making system. In some example embodiments, the hydrogen fired infrared oven 30 provides about 2 million Btu/hour of heat.

After drying and curing in the hydrogen fired infrared oven 30, the can bodies 1 may continue through the remainder of the can making system which may include, for example, inside coating and curing and necking.

The can making system further includes a water recycling system. The byproduct of burning hydrogen in the hydrogen fired infrared oven 30 is water. Other parts of the can making system, such as the can washer 40, use water. The can washer 40 may be disposed after the bodymaker in the can making system. The can washer 40 is structured to convey can bodies 1 through the can washer 40 and wash the can bodies by spraying water over the can bodies 1 as they pass through the can washer 40. Water used by the can washer 40 is cleaned and reused. However, despite cleaning and reusing water, there is some loss of water in the can washing process. As such, the can washer 40 requires an amount of make-up water to replenish the amount of lost water. In order to alleviate the need for supplying make-up water from an external source, the can making system includes the water recycling system that uses the spent fuel from the hydrogen fired infrared oven 30 to supply make-up water to the can washer 40. To this end, the water recycling system includes a first condenser 50 coupled to the hydrogen fired infrared oven 30. The first condenser 50 is structured to receive the water vapor resulting from the hydrogen burnt in the hydrogen fired infrared oven 30. The first condenser 50 is structured to condense the water vapor into water. The first condenser 50 is also coupled to the can washer 40 and is structured to provide the condensed water to the can washer 40 as make-up water. In some example embodiments, the water received as a byproduct of the burnt hydrogen is about 5 L per 1000 can bodies 1 dried and/or cured in the hydrogen fired infrared oven 30.

In addition to the water created as a byproduct of burning hydrogen in the hydrogen fired infrared oven 30, the drying and/or curing of the can bodies 1 results in vapors emitted from the heated can bodies 1. These vapors include water vapors and volatile organic compound (VOC) vapors. The water recycling system is structured to reclaim water from these vapors as well as provide for efficient disposal of the V OCs. To this extent, the water recycling system includes a second condenser 60 coupled to an exhaust of the hydrogen fired infrared oven 30 structured to receive vapors emitted from the can bodies 1. The second condenser 60 is structured to condense these vapors into liquid water and solid VOCs. The second condenser 60 is coupled to a separator 70. The separator 70 is structured to separate the liquid water 80 from the solid VOCs 90. The solid VOCs 90 may then be collected and taken away for disposal. For example and without limitation, the solid VOCs 90 may be loaded onto a vehicle 100 and transported away for disposal, thus eliminating airborne waste. The liquid water 80 is then provided to the can washer 40 as additional make-up water. Prior systems used a thermal oxidizer to burn off airborne VOCs in the oven exhaust. The can making system in accordance with the disclosed concept condenses VOCs to solid material for disposal, thus eliminating the need for a thermal oxidizer and its associated energy costs.

The can making system including the hydrogen fired infrared oven 30 and the water recycling system substantially reduces waste, including elimination of all airborne pollution. Further, by reclaiming water from the spent fuel and vapors in the hydrogen fired infrared oven 30 and reusing the water in the can washer 40, the can making system reduces the supply of water needed to operate the can making system.

It will be appreciated that the hydrogen fired infrared oven 30 and water recycling system may be employed in different aspects of the can making process without departing from the scope of the disclosed concept. For example, the hydrogen fired infrared oven 30 may be employed to cure internal coatings on can bodies, and may be located, for example and without limitation, after an inside spray machine structured to spray internal coatings onto internal surfaces of a can body. Similarly, the hydrogen fired infrared oven 30 may be employed to cure a base coat of a can body and may be located after a basecoater structured to apply the base coat to the can body. Further, it will be appreciated that the hydrogen fired infrared oven 30 may be structured to simultaneously dry and/or cure internal and external coatings on a can body. It will further be appreciated that in some applications, the hydrogen fired infrared oven 30 may be used as a can dryer located after or as part of the can washer 40.

It will be appreciated that in some example embodiments of the disclosed concept, any natural gas burner used in a can making system may be replaced with a hydrogen burner. That is, it will be appreciated that the disclosed concept is not limited to hydrogen fired infrared ovens and may be generally applied to hydrogen fired ovens. It will be appreciated that the water recycling system in accordance with the disclosed concept may be employed to reclaim the water byproduct from any type of hydrogen fired oven or dryer for use in a can washer or any other component that utilizes water. That is, the disclosed concept is applicable to both infrared ovens and dryers as well as other types of ovens and dryers.

It will also be appreciated that the water recycling system may reclaim water from any hydrogen fired infrared oven used in the can making system. Further, it will be appreciated that the reclaimed water may be used in any part of the can making process. While the reclaimed water is used in the can washer 40 in the example embodiment shown in FIG. 1, the reclaimed water may be used in any other part of the can making process that uses water.

It will be appreciated that a portion of the water recycling system may be employed in any ovens or dryers in a can making system, including natural gas fired ovens or dryers. For example, in natural gas fired ovens or dryers, (e.g., without limitation, pin ovens, natural gas fired infrared ovens, etc.), the second condenser 60 and separator 70 may be used to reclaim liquid water 80 for reuse in a can washer 40 and to separate solid VOCs 90 for disposal. That is, while a natural gas fired oven or dryer does not create water as a byproduct of burning as a hydrogen fired oven does, water can still be reclaimed from the exhaust of the natural fired gas oven and solid VOCs may still be separated from the exhaust of the natural fired gas oven. It will be appreciated that the second condenser 60 and separator 70 from the water recycling system may be employed with natural gas fired ovens or dryers to reclaim and reuse water and separate solid VOCs.

It will be appreciated that the disclosed concept also includes a method of recycling water in a can making system. For example, in some example embodiments of the disclosed concept, a method of recycling water in a can making system includes drying and/or curing coatings on can bodies conveyed through a hydrogen fired oven by burning hydrogen in the hydrogen fired oven, receiving water vapor from the hydrogen fired oven resultant from burning the hydrogen, condensing the water vapor into condensed water, and providing the condensed water to another component of the can making system. In some example embodiments of the disclosed concept, a method of recycling water in a can making system includes receiving vapors resultant from drying and/or curing coatings on the can bodies, condensing the vapors into liquid water and solid VOCs, separating the liquid water from the VOCs, and providing the liquid water to another component of the can making system. It will be appreciated that the methods of recycling water may provide condensed and/or liquid water to a can washer for use in a can washing process. It will also be appreciated that the methods of recycling water may be employed with any of the components of the can making system of FIG. 1 or in other can making systems.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A can making system comprising:
a hydrogen fired oven structured to burn hydrogen to dry and/or cure coatings on can bodies conveyed through the hydrogen fired oven; and
a water recycling system including a first condenser structured to receive water vapor from the hydrogen fired oven resultant from burning the hydrogen and to condense the water vapor into condensed water, and wherein the water recycling system is structured to provide the condensed water to another component of the can making system.

2. The can making system of claim 1, wherein the hydrogen fired oven is a hydrogen fired infrared oven including a number of radiant heating units, wherein the hydrogen fired infrared oven is structured to burn the hydrogen to heat the number of radiant heating units to cause the number of radiant heating units to emit infrared radiation to dry and/or cure coatings on the can bodies conveyed through the hydrogen fired infrared oven.

3. The can making system of claim 2, wherein the hydrogen fired infrared oven includes a conveyor system to move the can bodies through the hydrogen fired infrared oven, and wherein the number of radiant heating plates are disposed laterally on sides of the conveyor system.

4. The can making system of claim 3, wherein the hydrogen fired infrared oven includes about a 9 meter length where the can bodies are exposed to the number of radiant heating plates.

5. The can making system of claim 1, wherein the water recycling system is structured to provide the condensed water to a can washer for use in a can washing process.

6. The can making system of claim 1, wherein the water recycling system includes a second condenser structured to receive vapors resultant from drying and/or curing coatings of the can bodies and to condense the vapors into liquid water and solid volatile organic compounds (VOCs), and wherein the water recycling system includes a separator structured to separate the liquid water from the VOCs, and wherein the water recycling system is structured to provide the liquid water to another component of the can making system.

7. The can making system of claim 6, wherein the water recycling system is structured to provide the liquid water to a can washer for use in a can washing process.

8. A can making system comprising:
a gas fired oven structured to burn gas to dry and/or cure coating on can bodies conveyed through the gas fired oven; and
a water recycling system including a condenser structured to receive vapors resultant from drying and/or curing coatings of the can bodies and to condense the vapors into liquid water and solid volatile organic compounds (VOCs), and wherein the water recycling system includes a separator structured to separate the liquid water from the VOCs, and wherein the water recycling system is structured to provide the liquid water to another component of the can making system.

9. The can making system of claim 8, wherein the water recycling system is structured to provide the liquid water to a can washer for use in a can washing process.

10. A method of recycling water in a can making system, the method comprising:
drying and/or curing coatings on can bodies conveyed through a hydrogen fired oven by burning hydrogen in the hydrogen fired oven;
receiving water vapor from the hydrogen fired oven resultant from burning the hydrogen;
condensing the water vapor into condensed water; and
providing the condensed water to another component of the can making system.

11. The method of claim 10, wherein the hydrogen fired oven is a hydrogen fired infrared oven including a number of radiant heating units, wherein the hydrogen fired infrared oven is structured to burn the hydrogen to heat the number of radiant heating units to cause the number of radiant heating units to emit infrared radiation to dry and/or cure coatings on the can bodies conveyed through the hydrogen fired infrared oven.

12. The method of claim 11, wherein the hydrogen fired infrared oven includes a conveyor system to move the can bodies through the hydrogen fired infrared oven, and wherein the number of radiant heating plates are disposed laterally on sides of the conveyor system.

13. The method of claim 12, wherein the hydrogen fired infrared oven includes about a 9 meter length where the can bodies are exposed to the number of radiant heating plates.

14. The method of claim 10, wherein providing the condensed water to another component of a can making system includes providing the condensed water to a can washer for use in a can washing process.

15. The method of claim 10, further comprising:
receiving vapors resultant from drying and/or curing coatings on the can bodies;
condensing the vapors into liquid water and solid volatile organic compounds (VOCs);
separating the liquid water from the VOCs; and
providing the liquid water to another component of the can making system.

16. The method of claim 15, wherein providing the liquid water to another component of a can making system includes providing the liquid water to a can washer for use in a can washing process.
